(19) United States
(12) Patent Application Publication
(10) Pub. No.: US 2008/0078786 A1
(43) Pub. Date: Apr. 3, 2008

(54) Portable automatic watering apparatus using punctuated timed fluid release

(76) Inventor: Pejman Aazami, Toronto (CA)

Correspondence Address: PEJMAN AAZAMI, 409-485 Rosewell Avenue, Toronto, ON, M4R 2J2, CA

(21) Appl. No.: 11/891,704

(22) Filed: Aug. 14, 2007

Related U.S. Application Data
(60) Provisional application No. 60/837,991, filed on Aug. 17, 2006.

(51) Int. Cl. G05D 7/00

(52) U.S. Cl. 222/644

(57) ABSTRACT

Portable automated watering apparatus for plants are designed for continuous flow and do not release water at timed intervals. As a result, such apparatus do not facilitate sufficient soil saturation and therefore water does not distribute effectively throughout the soil. Other water punctuated water release apparatus are centralized and not portable. This is a portable automated watering apparatus for plants using punctuated timed interval water release. A mechanism in the invention after a predetermined delay period releases the contents of the fluid filled compartment(s). The mechanism consists of either a disk with aligning holes to the compartment(s) or water valves that open and close.

This application claims priority of provisional application Ser. No. 60/837,991 filed on Aug. 17, 2006. This invention relates to a portable automated watering apparatus for plants using punctuated timed interval water release.

Previous automated watering apparatus for plants are either not portable or are designed for continuous flow and do not release water at timed intervals. In addition, the portable designs rely on low flow rates to ensure that sufficient volume is released over time. Due to these low flow rates, such designs result in a limited depth of saturation of the soil by the water (e.g., CA 2050552) and therefore do not distribute water effectively throughout the soil. With such apparatus the flow rate is also dependent on the depth of water in the chamber, which results in decreased flow rates over time as water depth decreases. Consequently, less water is released over time, particularly during the time when it is needed the most by the plant.

Other apparatus are centralized and not portable, thus can only operate if plants are relocated to close proximity of the apparatus (e.g., CA 2053623, CA 2478873, and CA 2320022). These apparatus have limited practical applications for residential environments and situations where plants are not portable.

This patent is unique because it addresses the limitations of the above apparatuses. The invention is designed to provide punctuated high flow rates of water to plants. This allows for penetration of water to deep and superficial roots as soil becomes quickly saturated. The invention is also portable, such that it can be placed on or within plant proximity.

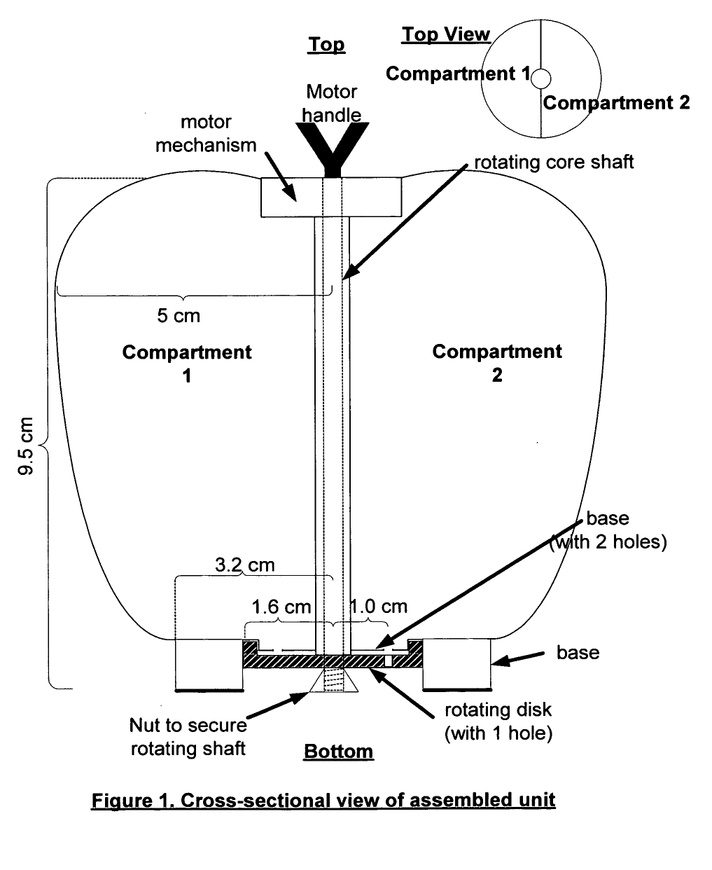

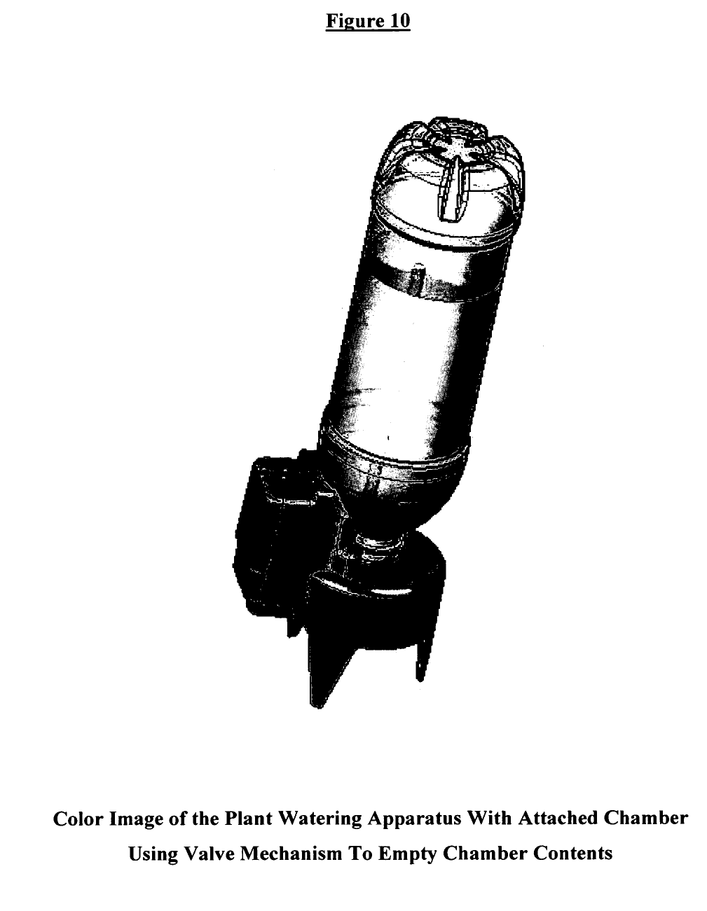

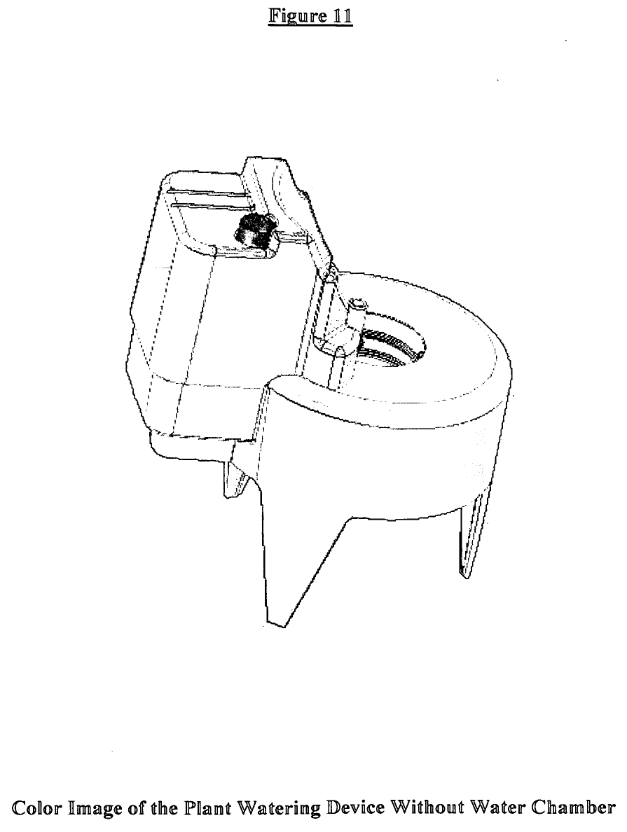

In the drawings which illustrate the embodiments of the invention, FIGS. 1 to 9 illustrate the disk mechanism to achieve punctuated water release. FIG. 10 to 12 illustrate the water valve design.

FIG. 1 is a cross section of the entire apparatus,

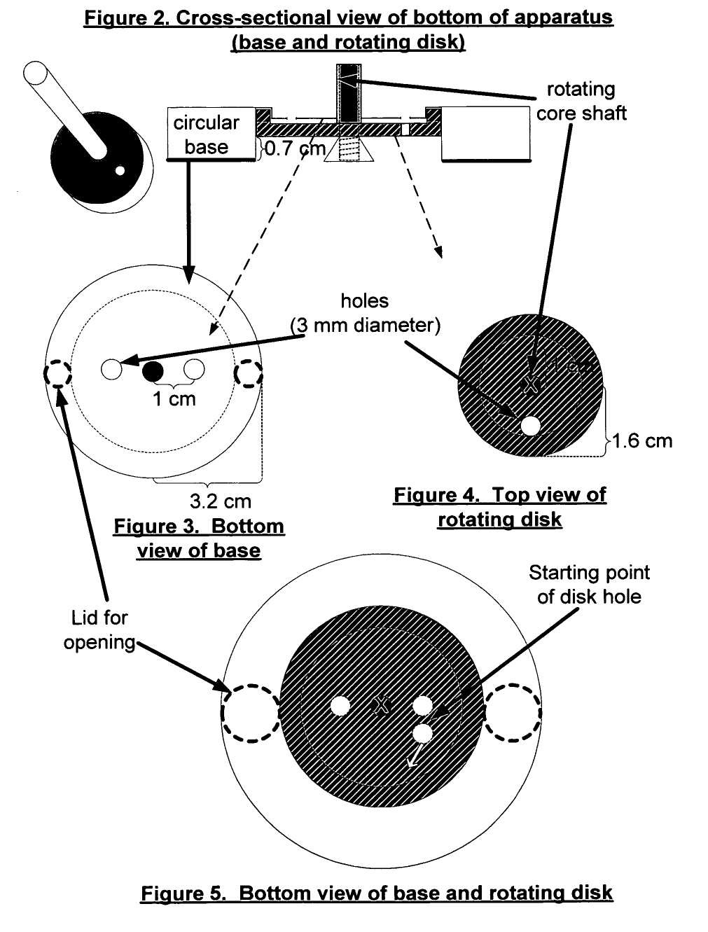

FIG. 2 is a cross-sectional view of the bottom portion of the apparatus (base and rotating disk),

FIGS. 3 and 4 show bottom and top views of the base and rotating disk, respectively, while

FIG. 5 shows the bottom view of the base and rotating disk when placed together.

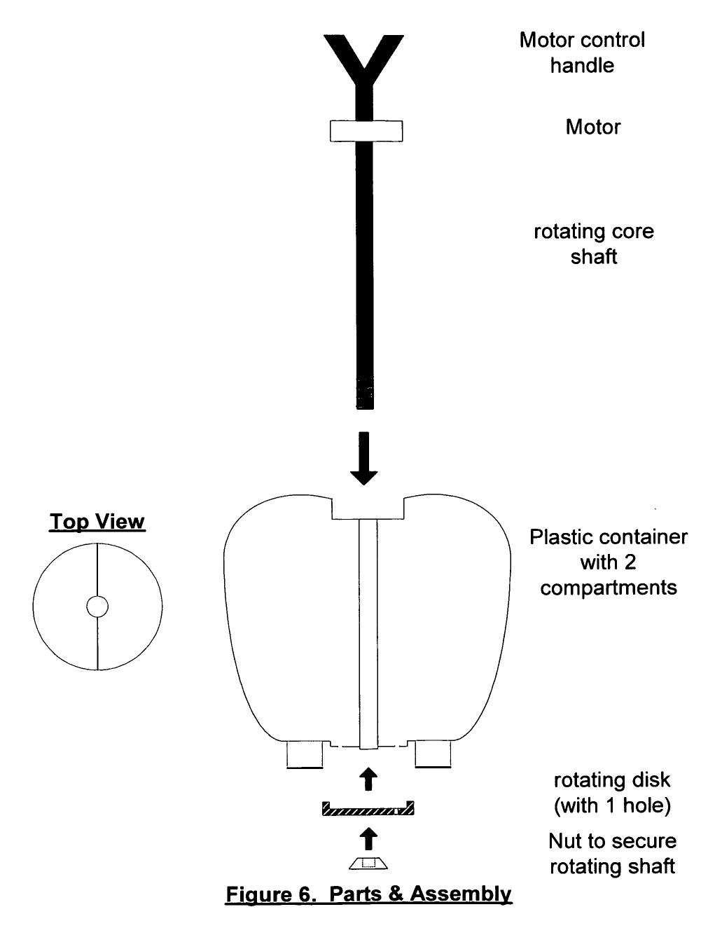

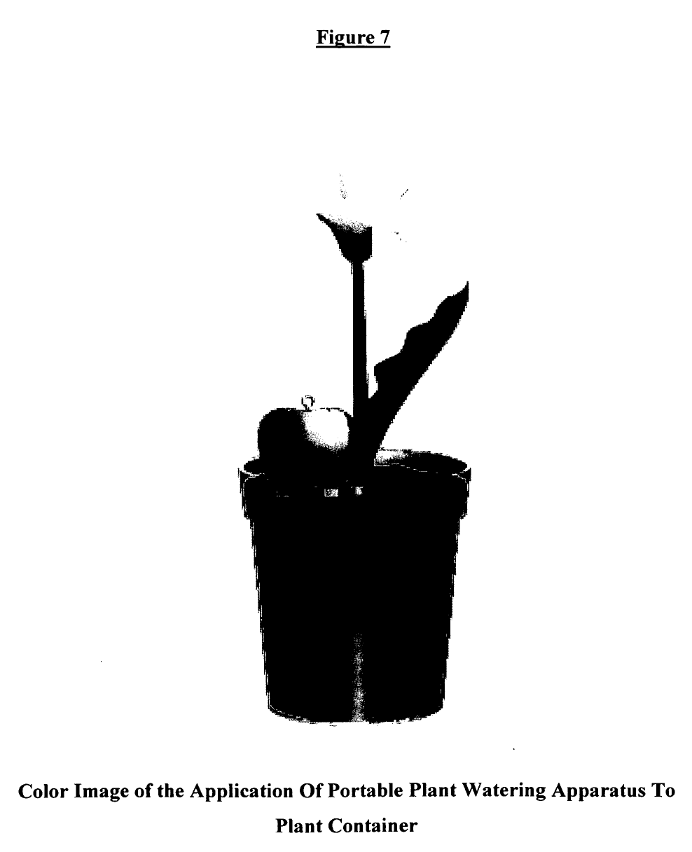

FIG. 6 shows the individual components.

FIGS. 7 to 9 are 3-D drawings that further illustrate the potential use of the product. The shape used in the drawing is only one example of the shape of the apparatus. Alternative shapes, sizes, volumes, varying number of holes, compartments, and positions where holes or mechanism are placed are also possible.

The compartments of the apparatus are filled with fluid through openings that are capped (in the Figures the openings are located in the base, but are not restricted to this location). The apparatus illustrated comprises of a rotating disk mechanism that rotates a shaft connected to a disk. When the mechanical or electrical mechanism is activated, the apparatus is designed to rotate the shaft and disk over a set period of time (e.g. 8 days/360°). When the hole in the rotating disk aligns with a hole in the base, the entire contents of the corresponding compartment are released. For example, if there are two compartments and the rotation is set for 8 days/360°, the first compartment will release its contents on day 4 and the second compartment will release its contents on day 8, approximately.

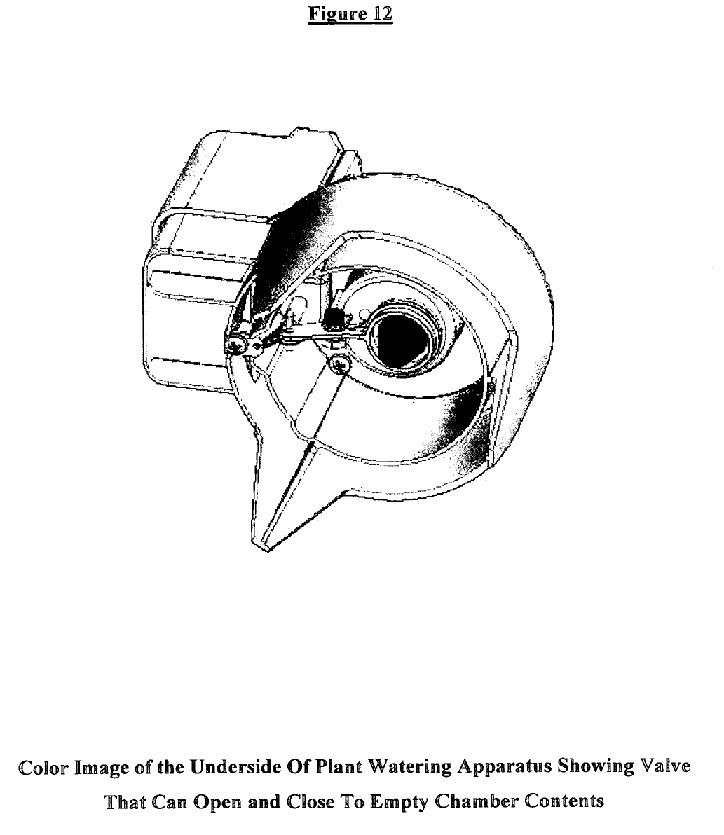

Diagrams 10 to 12 relate to the valve mechanism of water release. Valves can open and close using a mechanical or electrical mechanism at predetermined timed intervals to release partial or complete chamber contents. In FIG. 12, a water valve is controlled by an electrically activated solenoid. After the defined delay period the circuit board activates the solenoid to open the valves for a controlled period of time. An alternative mechanism is a spring loaded valve where the spring is compressed and set by the user and released by a mechanical or electrical method after a delay period. The duration of the valve opening can be set to release partial or complete chamber contents. The shape used in the drawing is only one example of the shape of the apparatus. Alternative dimensions, volumes, varying number of compartments, openings, valves, and positions where mechanism is placed are also possible.

All the above mechanisms equilibrate the pressure inside the chamber with the ambient through an additional hole(s) in the chamber(s) and/or through the main opening where water is released. Irrespective of the mechanism used to release the water this inventions primary feature is the punctuated release of the water and the portability of the device.

Description of Figures:

FIG. 1. Cross-sectional view of assembled unit.

FIG. 2. Cross-sectional view of bottom of apparatus (base and rotating disk).

FIG. 3. Bottom view of base.

FIG. 4. Top view of rotating disk.

FIG. 5. Bottom view of base and rotating disk.

FIG. 6. Parts and Assembly.

FIG. 7. Application of portable watering apparatus to plant container.

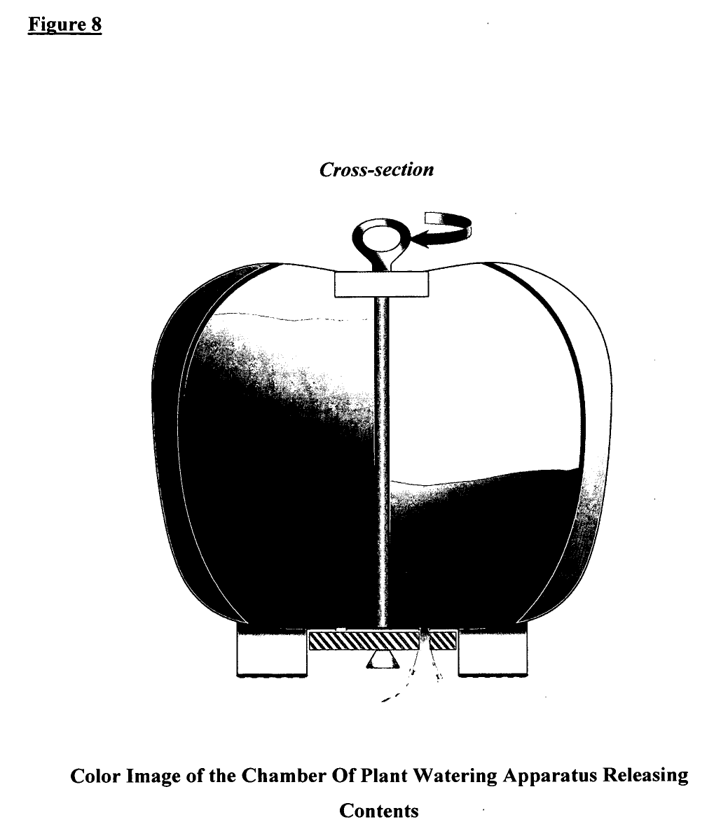

FIG. 8. Chamber of plant watering apparatus releasing contents.

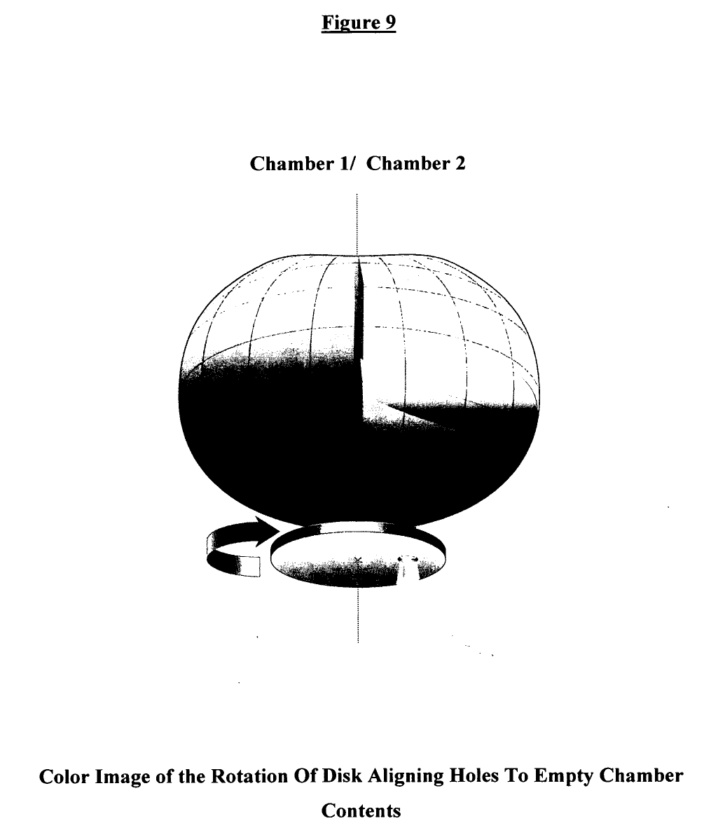

FIG. 9. Rotation of disk aligning holes to empty chamber contents.

FIG. 10. Plant watering apparatus with attached chamber using valve mechanism to empty chamber contents.

FIG. 11. Plant watering device without water chamber.

FIG. 12. Underside of plant watering apparatus showing valve that can open and close to empty chamber contents.

What is claimed is:

1. A portable apparatus with one or more chambers where the contents of the chambers are released to the outside at various time intervals.

2. The apparatus of claim 1 may have one or more chambers. Each chamber has a main opening to release the contents.

3. The apparatus of claim 1 equilibrates the pressure inside the chamber with the ambient through an additional hole(s) in the chamber(s) and/or through the main opening(s) of claim 2.

4. The apparatus of claim 1 may have a disk or object with one or more holes or openings which can potentially align with an opening in the chamber.

5. In the rotating disk mechanism of claim 4 an electrical or winding mechanism rotates the chambers or the disk at an angular rate for holes or openings to align and release contents from chambers to the outside.

6. The angular rotation of claim 5 can be set for various rates.

7. The apparatus of claim 1 can have valve(s) at the opening of chamber(s) that can open and close to release all or partial amounts of the chamber contents.

8. The time delay in the valve or spring mechanism can be set for various time periods.

9. Valve(s) can open and close using electrical, mechanical, or spring components.

10. The valve(s) of claim 7 can be set to open for various time periods to control volume released from chamber(s).

11. The opening(s) of the chamber(s) of claim 2 can be set to various sizes.

12. The chamber(s) of claim 2 can be of any dimension or volume and attached to the apparatus using various methods such as screwed or molded to the other components.
